(19) United States
(12) Patent Application Publication
(10) Pub. No.: US 2026/0366825 A1
(43) Pub. Date: Nov. 19, 2026

(54) HEAT EXCHANGER

(71) Applicant: GM GLOBAL TECHNOLOGY OPERATIONS LLC, Detroit, MI (US)

(72) Inventor: Dale MILLER, Rochester Hills, MI (US)

(21) Appl. No.: 19/208,063

(22) Filed: May 14, 2025

(51) Int. Cl. F28F 1/12; B60H 1/00

(52) U.S. Cl. CPC F28F 1/12; B60H 1/00278; B60H 1/00328

(57) ABSTRACT

A heat exchanger including: a body with a three-dimensional repeating lattice structure; first fluid channels defined by the body; second fluid channels defined by the body; and sidewalls separating the first fluid channels from the second fluid channels, the sidewalls including pointed tips spaced apart along the sidewalls and separated by curved surfaces of the sidewalls. The heat exchanger is formed by additive manufacturing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to heat exchangers configured to transfer thermal energy between two or more fluids.

Heat exchangers transfer thermal energy between two or more fluids without mixing the fluids. Heat exchangers are used in both cooling and heating processes. The fluids may be separated by a solid wall to prevent mixing or they may be in direct contact. Heat exchangers are used in, for example, automotive applications, space heating, refrigeration, air conditioning, power stations, chemical plants, petrochemical plants, petroleum refineries, natural-gas processing, sewage treatment, etc. An example of a heat exchanger is found in an internal combustion engine in which engine coolant flows through radiator coils and air flows past the coils, which cools the coolant and heats the incoming air. Another example is a heat sink, which is a passive heat exchanger that transfers the heat generated by an electronic or a mechanical device to a fluid medium, often air or a liquid coolant. Heat exchangers are also used in electric vehicles for thermal management.

### SUMMARY

The present disclosure includes a heat exchanger including: a body with a three-dimensional repeating lattice structure; first fluid channels defined by the body; second fluid channels defined by the body; and sidewalls separating the first fluid channels from the second fluid channels, the sidewalls including pointed tips spaced apart along the sidewalls and separated by curved surfaces of the sidewalls. The heat exchanger is formed by additive manufacturing.

In further features, the body is configured as a modified complex, triply periodic minimal surface (TPMS) structure modified to include the pointed tips.

In further features, the heat exchanger is configured for installation in a battery temperature regulation system of a vehicle.

In further features, the heat exchanger is configured for installation in a heating, ventilation, and air conditioning (HVAC) system of a vehicle.

In further features, the sidewalls are shaped corresponding to a non-sinusoidal wave function.

In further features, the sidewalls are shaped corresponding to end points of triangular facets that are coincident to a continuously curved TPMS structure.

In further features, the sidewalls are shaped corresponding to a blend of a non-sinusoidal wave function and end points of triangular facets that are coincident to a continuously curved TPMS structure.

In further features, the pointed tips include peak points of the sidewalls.

In further features, the pointed tips are apex points of the sidewalls.

The present disclosure also provides for a heat exchanger including: a body with a three-dimensional repeating lattice structure configured as a modified complex, triply periodic minimal surface (TPMS) structure; first fluid channels defined by the body; second fluid channels defined by the body; and sidewalls separating the first fluid channels from the second fluid channels, the sidewalls including pointed peaks spaced apart along the sidewalls and separated by curved surfaces of the sidewalls. The heat exchanger is formed by additive manufacturing.

In further features, the pointed peaks include pointed tips of the sidewalls. In further features, the pointed peaks are apex points of the sidewalls.

In further features, the body is configured as the modified complex, triply periodic minimal surface (TPMS) structure modified to include the pointed peaks.

In further features, the heat exchanger is configured for installation in a battery temperature regulation system of a vehicle.

In further features, the heat exchanger is configured for installation in a heating, ventilation, and air conditioning (HVAC) system of a vehicle.

In further features, the sidewalls are shaped corresponding to a non-sinusoidal wave function.

In further features, the sidewalls are shaped corresponding to end points of triangular facets that are coincident to a continuously curved TPMS structure.

In further features, the sidewalls are shaped corresponding to a blend of a non-sinusoidal wave function and end points of triangular facets that are coincident to a continuously curved TPMS structure.

The present disclosure also provides for, in various features, a vehicle including: wheels; a body supported by the wheels; and a heat exchanger. The heat exchanger includes: a body including a three-dimensional repeating lattice structure; first fluid channels defined by the body; second fluid channels defined by the body; and sidewalls separating the first fluid channels from the second fluid channels, the sidewalls including pointed tips spaced apart along the sidewalls and separated by curved surfaces of the sidewalls. The heat exchanger is formed by additive manufacturing.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an exemplary heat exchanger in accordance with the present disclosure;

FIG. 2 is a cross-sectional view of the heat exchanger of FIG. 1;

FIG. 3A is a cross-sectional view of exemplary heat exchanger fluid channels defined by a wall configured in accordance with the present disclosure;

FIG. 3B is another cross-sectional view of exemplary heat exchanger fluid channels defined by a wall configured in accordance with the present disclosure;

FIG. 4 is an additional cross-sectional view of exemplary heat exchanger fluid channels defined by a wall configured in accordance with the present disclosure;

FIG. 5 is a further cross-sectional view of exemplary heat exchanger fluid channels defined by a wall configured in accordance with the present disclosure;

FIG. 6 is still another cross-sectional view of exemplary heat exchanger fluid channels defined by a wall configured in accordance with the present disclosure;

FIG. 7 is an additional cross-sectional view of exemplary heat exchanger fluid channels defined by a wall configured in accordance with the present disclosure;

FIG. 8 is a cross-sectional view of exemplary heat exchanger fluid channels defined by a wall configured in accordance with the present disclosure;

FIG. 9 is a further cross-sectional view of exemplary heat exchanger fluid channels defined by a wall configured in accordance with the present disclosure;

FIG. 10 is a perspective view of an exemplary heat exchanger body defining heat exchanger channels in accordance with the present disclosure;

FIG. 11 is a cross-sectional view of another heat exchanger wall defining a heat exchanger channel in accordance with the present disclosure;

FIG. 12 is a perspective view of a heat exchanger body in accordance with the present disclosure;

FIG. 13 is a perspective view of an additional heat exchanger body in accordance with the present disclosure;

FIG. 14 is a perspective view of a further heat exchanger body in accordance with the present disclosure;

FIGS. 15A, 15B, and 15C illustrate additional heat exchanger sidewalls in accordance with the present disclosure defining heat exchanger fluid channels; and

FIG. 16 is a perspective view of an exemplary vehicle configured to include one or more heat exchangers in accordance with the present disclosure.

In the drawings, reference numbers may be reused to identify similar and/or identical elements.

### DETAILED DESCRIPTION

The present disclosure is directed to heat exchangers formed by additive manufacturing. The heat exchangers of the present disclosure may be formed by any suitable additive manufacturing process. Additive manufacturing is often referred to as three-dimensional printing. Exemplary additive manufacturing processes include, but are not limited to, the following: fused deposition modeling (FDM); stereolithography (SLA); digital light processing (DLP); selective laser sintering (SLS); direct metal laser sintering (DMLS); selective laser melting (SLM); electron beam melting (EBM); metal binder jetting; sand binder jetting; polyjet/multijet modeling (MJM); laser metal deposition (LMD); laminated object manufacturing (LOM); etc.

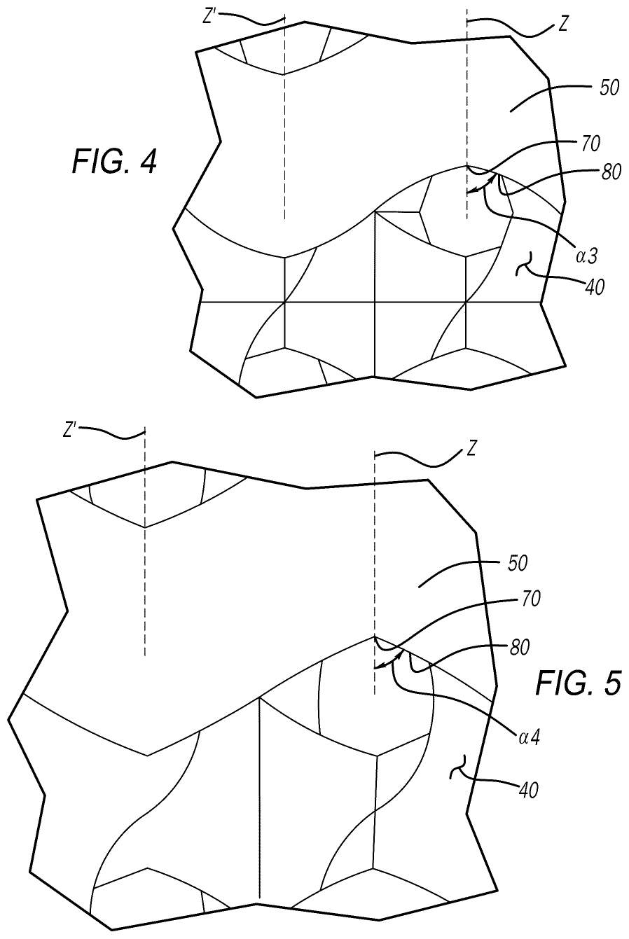

The heat exchangers of the present disclosure define two or more fluid channels to accommodate different fluids. The fluid channels are intertwined and configured to simultaneously transfer heat between the different fluids. Because all of the channels are intertwined throughout a majority of the heat exchangers, the heat exchangers of the present disclosure are configured to enhance heat exchange between the different fluids and improve the overall efficiency of the heat exchangers. The present disclosure also encompasses single fluid heat transfer applications, such as heat sinks or internal cooling channels. This can be achieved by, for example, (1) only creating one fluid channel A or (2) having the same fluid pass through both channels A and B. FIGS. 4-7, 11, and 15 illustrate exemplary structures with only one fluid channel.

The present disclosure is directed to heat exchangers including any complex, triply periodic minimal surface (TPMS) structure. Exemplary TPMS structures include, but are not limited to, the following: gyroid; Schwarz; neovius, lidinoid, split P, and diamond. The following description of gyroid based heat exchangers is applicable to any other TPMS structures as well. The present disclosure thus encompasses all TPMS based heat exchangers and is not limited to gyroid based heat exchangers.

Gyroid heat exchangers define fluid passageways that have an overall gyroid shape. Gyroids have a smooth, non-self-intersecting surface with no straight lines. A gyroid heat exchanger is periodic in three-dimensions, meaning that the gyroid pattern of fluid channels repeats in all three spatial directions. Gyroid based heat exchangers have a high surface area-to-volume ratio and interconnected channels, which makes the gyroid structure of fluid passageways suitable for enhancing mixing and thermal exchange. The continuous gyroid surfaces promote efficient conduction and convection while minimizing pressure drop (depending on the design). Gyroid structures may replace finned or plate-based heat exchanger configurations.

Gyroid and other TPMS based heat exchangers traditionally include rounded channel ceiling surfaces. The rounded ceiling surfaces may limit manufacturability by presenting surface finishing issues and limiting minimum wall thicknesses. The present disclosure advantageously provides for pointed variations of TPMS based heat exchangers that reduce, or eliminate, such rounded channel ceiling surfaces.

With traditional gyroid and other TPMS heat exchangers, curvature of channel geometry may present issues during build preparation when curves are translated into vectors. The high curvature of gyroid based heat exchangers, for example, may require tens of millions of vectors to be created, which may result in large, bulky files and extended processing times. The present disclosure advantageously provides for modified TPMS shaped channel generation (including gyroid channel generation) using planar facets to reduce the vector quantity of the heat exchangers.

The heat exchangers of the present disclosure are configured for use in any suitable automotive and non-automotive applications. With respect to automotive applications, for example, the heat exchangers may be configured to facilitate thermal management. For example, and with respect to battery thermal management, the heat exchangers of the present disclosure are configured to help maintain a battery pack at optimal temperature. The heat exchangers can cool the battery when it gets too hot, and warm the battery in cold conditions to ensure efficient operation.

With respect to cabin heating and cooling, the heat exchangers of the present disclosure may be configured for use with the heating, ventilation, and air conditioning (HVAC) system of any suitable fully electric vehicle (or partially electric vehicle) to manage cabin temperature. The heat exchangers of the present disclosure may be configured to cool vehicle motors and cool vehicle electronics. The heat exchangers may be configured for use with reversible heat pumps, which can act as both a heater and a cooler. The systems are able to transfer excess heat from the battery to the cabin or vice versa, thereby improving efficiency of the system. The heat exchangers of the present disclosure are configured for any other suitable automotive and non-automotive applications as well.

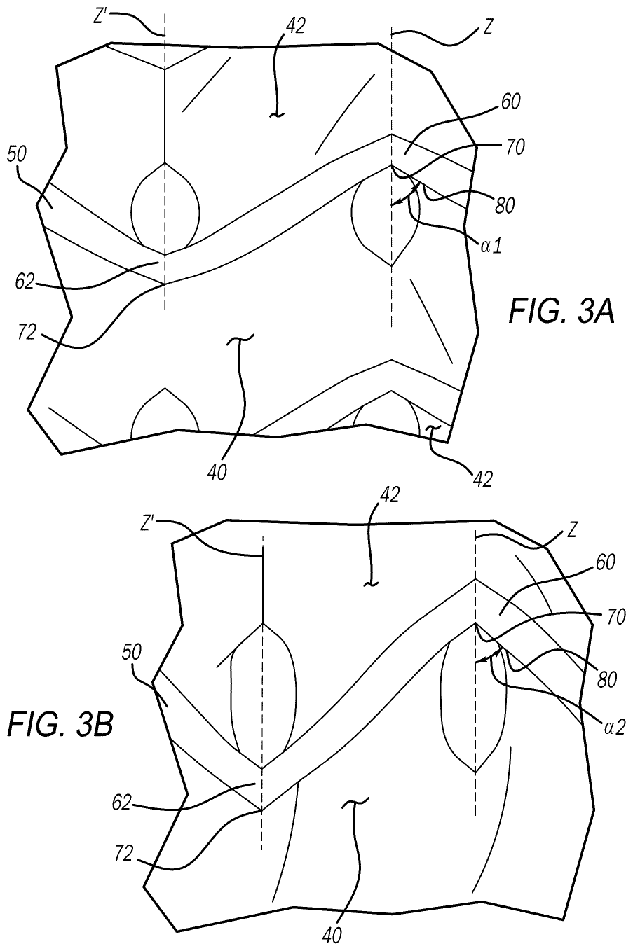

The present teachings reduce the maximum overhang angles of TPMS structures, which improves manufacturability. The structures may include round/curved surfaces and overhangs as long as the apex points, specifically of peak points 70 and trough points 72, are without continuous, rounded curvatures. For example, at the peak points 70 and the trough points 72 of FIGS. 3A and 3B, two curved surfaces meet at an intersection, creating the peak points 70 and the trough points 72. The peak points 70 and the trough points 72 are pointed tips of sidewalls 50. The surfaces adjacent to the peak points 70 and the trough points 72 may be rounded/curved as long as the tangent lines for those curves remains below a certain threshold (45° for example) relative to a build plate that the structure is formed on by additive manufacturing.

For TPMS structures (standard and modified to include the peak points 70 and the trough points 72 per the present disclosure), the maximum overhang angle of the structure is located at the peak and trough (relative to the build plate) regions of the structures. In a standard gyroid structure angle α approaches 90° at the structure's theoretical peak and trough points, even if the structure is asymmetrically scaled. For a structure formed by additive manufacturing to be considered self-supporting, the maximum overhang angles are commonly kept at 45° or less relative to the build direction. Self-supporting means that the addition of external support structures is not required for manufacturing. If the maximum overhang angles of a part's downskin surfaces are greater than the specified threshold for self-supported manufacturing (45° for example), external support structures are typically required to enable manufacturing, prevent print failures, and prevent surface defects that would otherwise be produced if attempting to manufacture the regions without the aid of external support structures.

TPMS based metal heat exchangers typically cannot be manufactured with external support structures inside of the channels. This is because support structure removal from internal TPMS lattice channels is typically not achievable due to their inaccessibility. Further, even if support removal were possible, it would be detrimental due to the added support removal post processing required. For standard TPMS based heat exchangers, channel surface regions with overhang angles α well above 45° (approaching 90°) must be manufactured without support structures. Manufacturing high overhang angle regions without using support structures may lead to surface irregularities.

The maximum overhang angle for unsupported manufacturing varies by factors including manufacturing technology, type of machinery used, print parameters, etc. While the maximum overhang angle for unsupported manufacturing varies from 45°, it can be generalized that the higher the maximum overhang angle, the greater risk of print irregularities when printing without external supports. Due to the reduced overhang angle α2, the part illustrated in FIG. 3B thus has reduced risk of print irregularities as compared to the part of FIG. 3A. Likewise, the FIG. 3A part has a reduced risk of print irregularities as compared to a standard gyroid heat exchanger geometry not including peaks, in which angle α approaches the extremely high overhang angle of 90°.

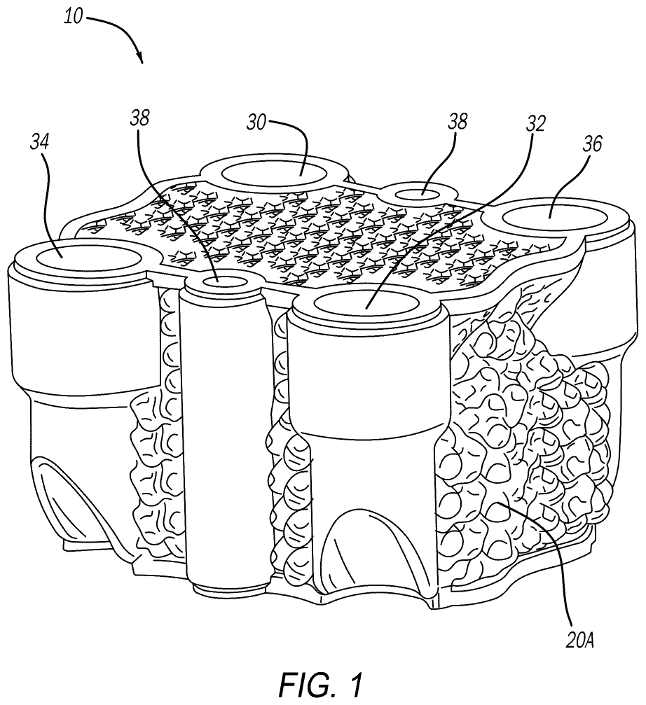

FIG. 1 illustrates an example of a heat exchanger 10 in accordance with the present disclosure. The heat exchanger 10 generally includes a body 20A with a plurality of TPMS shaped fluid channels, such as gyroid shaped fluid channels as explained in detail herein. The body 20A may be configured with any other TPMS shaped fluid channels in place of, or in addition to, the gyroid shaped fluid channels. The following description of the gyroid shaped fluid channels applies to fluid channels having any other TPMS structure as well. The heat exchanger 10 of FIG. 1 is provided as merely one example of a heat exchanger in accordance with the present disclosure. The heat exchanger 10 may be configured in any other suitable manner with any other suitable shape and layout.

A first inlet 30 and a first outlet 32 are in fluid communication with first gyroid shaped fluid channels of the body 20A. The heat exchanger 10 also includes a second inlet 34 and a second outlet 36 in fluid communication with second gyroid shaped fluid channels of the body 20A. An exterior of the body 20A is corrugated in areas of the gyroid-shaped fluid channels. The heat exchanger 10 defines receptacles 38, which are configured to receive any suitable fasteners for mounting the heat exchanger 10 at any suitable installation site.

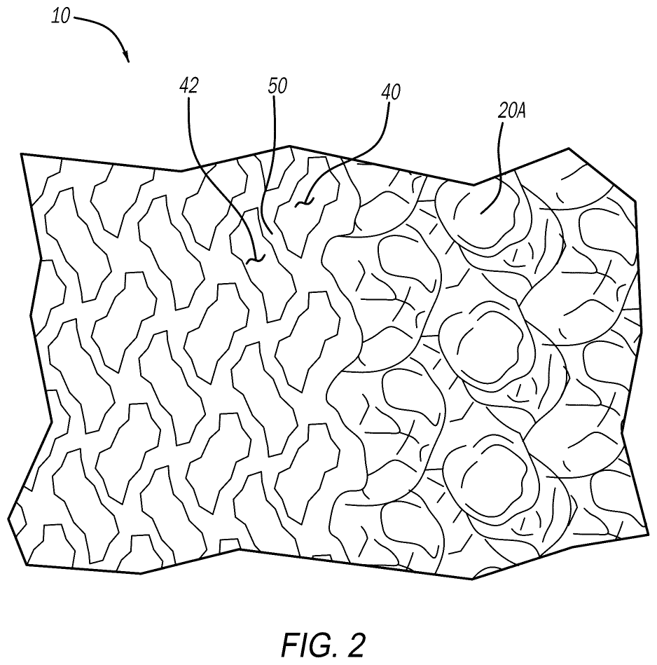

With additional reference to FIG. 2, the body 20A defines first fluid channels 40 and second fluid channels 42, which are not in fluid communication with the first fluid channels 40. The first fluid channels 40 and the second fluid channels 42 are a plurality of gyroid shaped channels. The first fluid channels 40 and the second fluid channels 42 are all generally provided as a gyroid lattice structure, which may be formed in any suitable manner, such as by any suitable additive manufacturing process (e.g., 3D-printing). The first fluid channels 40 and the second fluid channels 42 may have any other suitable TPMS shape as well.

In the examples illustrated, the heat exchanger 10 includes two sets of gyroid shaped fluid channels—the first fluid channels 40 and the second fluid channels 42. But the heat exchanger 10 may be configured to include any suitable number of additional fluid channels for accommodating heat exchange between any suitable number of additional fluids. The additional fluid channels will be intertwined with the first fluid channels 40 and the second fluid channels 42. Any suitable number of additional fluid channels may be included, such as, but not limited to, 1, 2, 3, 4, 5, 10, 50, 100, etc. The first fluid channels 40, the second fluid channels 42, and any additional fluid channels that may be included are all intertwined to permit transfer of thermal energy between the first fluid channels 40, the second fluid channels 42, and the additional fluid channels.

The first fluid channels 40 are in fluid communication with the first inlet 30 and the first outlet 32. The first fluid channels 40 are not in fluid communication with the second inlet 34 or the second outlet 36. From the first inlet 30, a first fluid will flow through the first fluid channels 40 and exit the heat exchanger 10 through the first outlet 32. The second fluid channels 42 are not in fluid communication with the first inlet 30 or the first outlet 32.

The second fluid channels 42 are in fluid communication with the second inlet 34 and the second outlet 36. The second fluid channels 42 are not in fluid communication with the first inlet 30 or the first outlet 32. From the second inlet 34, a second fluid will flow through the second fluid channels 42 and exit the heat exchanger 10 through the second outlet 36. The first fluid channels 40 are not in fluid communication with the second inlet 34 or the second outlet 36.

The first fluid channels 40 and the second fluid channels 42 are intertwined with each other. As illustrated in FIG. 2, for example, sidewalls 50 of the body 20A define the first fluid channels 40 and the second fluid channels 42, and separate the first fluid channels 40 from the second fluid channels 42. The sidewalls 50 are configured to permit transfer of thermal energy between the first fluid flowing through the first fluid channels 40 and the second fluid flowing through the second fluid channels 42 without mixing the first fluid and the second fluid.

FIG. 3A is a cross-sectional view of two adjacent ones of the first fluid channels 40 and the second fluid channels 42. The sidewall 50 separating the first fluid channel 40 from the second fluid channel 52 is generally wave-shaped and includes a series of peaks and troughs. In the example of FIG. 3A, relative to the first fluid channel 40, the sidewall 50 includes a peak 60 and a trough 62. With traditional TPMS heat exchangers (including gyroid based heat exchangers), the wall between fluid channels is continuously curved along the peaks and troughs. In contrast, however, the sidewall 50 of the present disclosure is not continuously smooth at the peak 60 and the trough 62. Rather, the sidewall 50 includes curved surfaces, which converge to define a peak point 70 at the peak 60, and a trough point 72 at the trough 62 (see FIGS. 3A, 3B, as well as throughout the remaining figures, for example).

For example, adjacent to the peak 60 and the peak point 70 are curved wall surfaces 80. The curved wall surface 80 directly adjacent to the peak point 70 extends from the peak point 70 at an angle α of less than 90° relative to a longitudinal line Z extending through the peak point 70 (and less than 90° relative a build plate that the structure is formed on by additive manufacturing). The longitudinal line Z extends parallel to a longitudinal line Z′ extending through the trough point 82. The angle α may be any suitable angle less than 90°. In the example of FIG. 3A, the angle α1 is about 45°. In the example of FIG. 3B, the angle α2 is less than 45°. Thus, at the peak point 70 and at the trough point 72 the sidewalls 50 are not rounded, but rather come to a point or peak. This shape facilitates formation of the sidewall 50 as described herein, such as by reducing overhang of deposited material.

In accordance with the present disclosure, the shape of the sidewall 50 may be arrived at as follows: (1) equation derived using non-sinusoidal wave functions (equation derived); (2) by mapping and patterning end points of triangular facets that are coincident to standard gyroid (or other TPMS) surfaces (planar facet); or (3) by blending equation derived gyroid (or other TPMS) structures with planar facet gyroid structures using implicit modeling (curved facet).

Shaping the sidewall 50 using the equation derived, planar facet, or curved facet techniques improves manufacturability of the TPMS heat exchanger by material deposition. For example, rounded overhangs at the peaks 60 and the troughs 62 are eliminated. Such rounded overhangs are difficult to manufacture and may present various structural issues. By eliminating such structural issues, the sidewalls 50 may be made relatively thinner as compared to previous TPMS heat exchangers. Thinner sidewalls improve heat transfer, and thus the heat exchanger 10 of the present disclosure generally has increased heat transfer capacity as compared to prior TPMS heat exchangers. While maintaining channel size, wall thickness reduction also enables cell size reduction, thereby increasing system surface area and further improving heat transfer. The teachings of the present disclosure also improve surface finishing at the sidewalls 50, and reduce any risk for production of loose debris on downskin surfaces of the heat exchangers of the present disclosure.

Examples of shaping the sidewall 50 using the equation derived techniques will now be described. A lattice field of the body 20A is created by a user inputting, with any suitable user interface, pointed TPMS equations into any suitable design program. To generate a pointed TPMS, one or more sinusoidal wave function of a standard TPMS structure is replaced with the corresponding triangle wave function as detailed below:

| TPMS | |
|---|---|
| Structure | Formula For Standard TPMS Structure |
| Gyroid | sin(x) cos(y) + sin(y) cos(z) + sin(z) cos(x) |
| Schwarz | cos(x) + cos(y) + cos(z) |
| Diamond | sin(x)*sin(y)*sin(z) + sin(x)*cos(y)*cos(z) + |
| | cos(x)*sin(y)*cos(z) + cos(x)*cos(y)*sin(z) |
| Neovius | 3*(cos(x) + cos(y) + cos(z)) + 4*cos(x)*cos(y)*cos(z) |

| Standard TPMS Sinusoidal | Replacement Function for |
|---|---|
| Wave Function | Pointed TPMS Triangle Wave Function |
| sin(φ) | (2/π)arcsin(sin(φ)) |
| cos(φ) | 1-(2/π)arccos(cos(φ))) |

The user then asymmetrically scales, such as by using the design program, the lattice field in a Z build direction to provide a desired angle α that will result in an overhang angle α that is less than 90°, for example. Using the design program, the user will then shell the lattice field with an offset value to create walls for the first fluid channels 40, the second fluid channels 42, and any additional fluid channels. The user will then use the design program to Boolean intersect the lattice field with the design space of the heat exchanger. The overhang angle α for pointed lattice channels generated in accordance with the present disclosure will already have overhang angle α as always less than 90°, even prior to scaling. Through scaling pointed TMPS structures, that angle can be reduced as needed to comply with the maximum recommended unsupported overhang angle for any technology/printer/parameter, etc. This has not been possible previously because with standard gyroid heat exchangers the overhang angle α always approaches 90° at the theoretical peak/trough points. This scaling of the structure is optional. Unscaled pointed TPMS structures have superior overhang angles as compared to unscaled standard TPMS structures.

FIG. 4 illustrates a sidewall 50 in accordance with the present disclosure formed by the equation derived technique described above. An exemplary non-sinusoidal triangle waveform equation with amplitude (1) and period (2) that may be used to form the sidewall 50 of FIG. 4 is as follows:

(2/π arcsin(sin [symbol] (x)) [symbol] )(1−2/π arccos(cos(y)))+(2/π arcsin(sin(y)))(1−2/π arccos(cos(z)))+(2/π arcsin(sin(z)))(1−2/π arccos(cos(x))).

The sidewall 50 of FIG. 4 defines an angle α3 between the longitudinal line Z and the wall surface 80 that is directly adjacent to the peak point 70. The angle α3 is less than 90°.

With reference to FIG. 5, non-sinusoidal triangle wave functions are used for wave forms in X and Y directions, while in the Z direction the wave form remains sinusoidal. An exemplary equation for forming the sidewall 50 of FIG. 5 is as follows:

(2/π arcsin(sin [symbol] (x)) [symbol] )(1−2/π arccos(cos(y)))+(2/π arcsin(sin(y)))(cos(z))+(sin(z))(1−2/π arccos(cos(x))).

The sidewall 50 of FIG. 5 defines an angle α4 between the longitudinal line Z and the wall surface 80 that is directly adjacent to the peak point 70. The angle α4 is less than 90°.

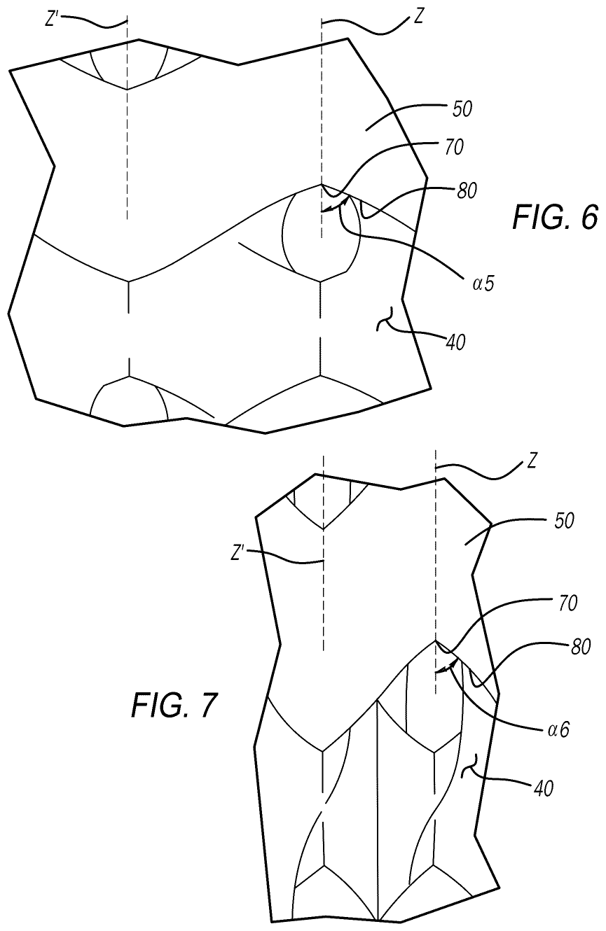

With reference to FIG. 6, waveforms of the sidewall 50 in the X and Y directions are formed in accordance with the present disclosure using a combination of sinusoidal and non-sinusoidal triangle wave functions while the z direction wave form remains sinusoidal. An exemplary equation for forming the sidewall 50 of FIG. 6 is as follows:

(sin(x))(cos(y))+(2/π arcsin(sin(y)))(cos(z))+(sin(z))(1−2/π arccos(cos(x))).

The sidewall 50 of FIG. 6 defines an angle α5 between the longitudinal line Z and the wall surface 80 that is directly adjacent to the peak point 70. The angle α5 is less than 90°. The three formulas listed above are provided for exemplary purposes only. There are six sinusoidal functions in the standard gyroid formula. Replacing any or all of these functions with the corresponding triangle wave function produces a potential equation derived pointed gyroid structure.

The lattice structure formed in FIGS. 4-6, for example, is (optionally) asymmetrically scaled in the Z build direction such that a maximum downskin overhang angle is within a self-supporting angle threshold of a specified additive manufacturing process with respect to, for example, the additive manufacturing technology, the printer used, the material used, layer height, etc. The asymmetric scaling may be performed by, for example, asymmetrically scaling the generated lattice field in the Z direction, or by adjusting the pointed gyroid equation (i.e., adjusting the amplitude values in the X and Y waveforms and/or the period values in the Z waveforms). Maximum overhang angles of the structures may be verified using any suitable design tooling, such as draft analysis or angle analysis.

With reference to FIGS. 7-9, using the design program the lattice field is shelled to form hollow walls with distinct channels, such as the first fluid channels 40 and the second fluid channels 42. The pointed TPMS structures (such as pointed, walled gyroid structures) may have uniform or varying sizes of the first fluid channels 40 and the second fluid channels 42. To create varying sizes of the first fluid channels 40 and the second fluid channels 42, the pointed TPMS field (such as the gyroid field) is shelled.

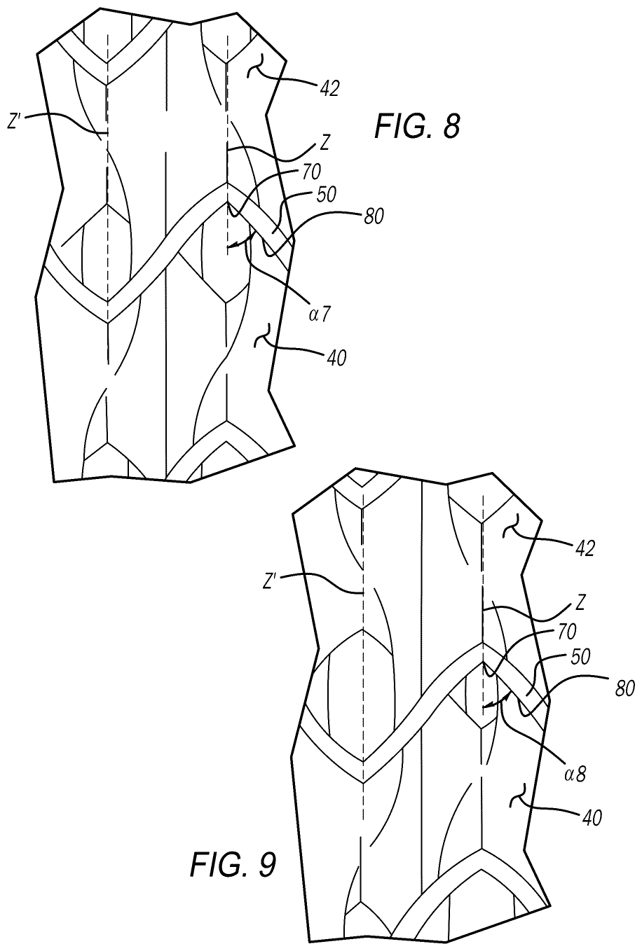

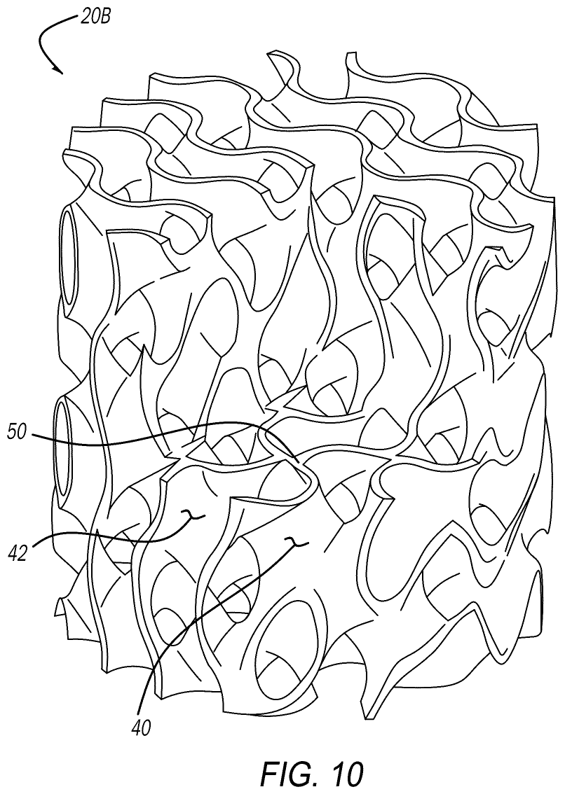

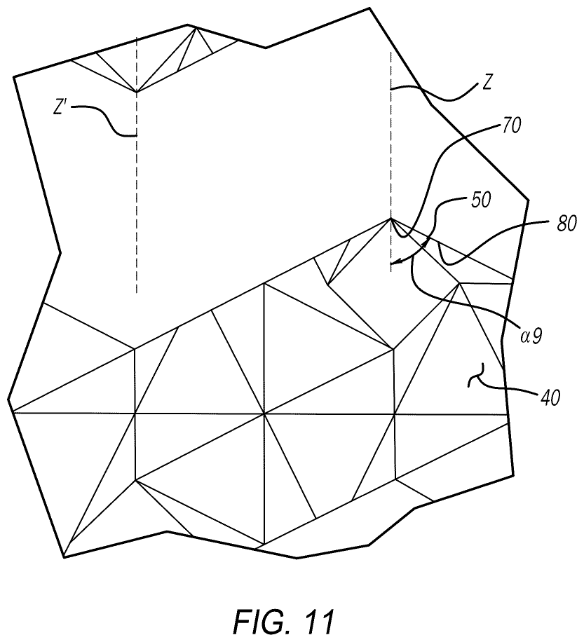

FIG. 7 illustrates the lattice heat exchanger structure prior to shelling. FIG. 8 illustrates the shelled structure defining the first fluid channels 40 and the second fluid channels 42 with no offset. The structure of FIG. 7 defines an angle α6 between the longitudinal line Z and the wall surface 80, and the structure of FIG. 8 defines an angle α7. Angle α6 and angle α7 are equal. FIG. 9 illustrates the shelled structure with an offset. FIG. 10 illustrates an exemplary body 10B of a heat exchanger with the gyroid field trimmed to size following Boolean intersection with a design space. The body 20B includes the structure illustrated in FIG. 8 and/or FIG. 9.

With reference to FIGS. 11-13, exemplary generation of the first fluid channels 40 and the second fluid channels 42 by mapping and patterning end points of equilateral triangular facets that are coincident to standard gyroid surfaces (planar facet technique) will now be described. Planar facet gyroid structures are made up of tessellating planar facets with end points that are coincident/conformal to standard gyroid surfaces.

Initially, using any suitable design software, end points are mapped for a planar facet unit cell. And triangular facets are mapped for the unit cell. Next, the unit cell map is (optionally) asymmetrically scaled in the Z build direction to comply with overhang angle requirements of the particular application and the particular additive manufacturing process to be used. To create walls for the first fluid channels 40 and the second fluid channels 42, the unit cell is shelled with any suitable offset value. The shelled unit cell is then mapped over the design space of the heat exchanger, and the lattice structure is Boolean intersected with the design space of the heat exchanger.

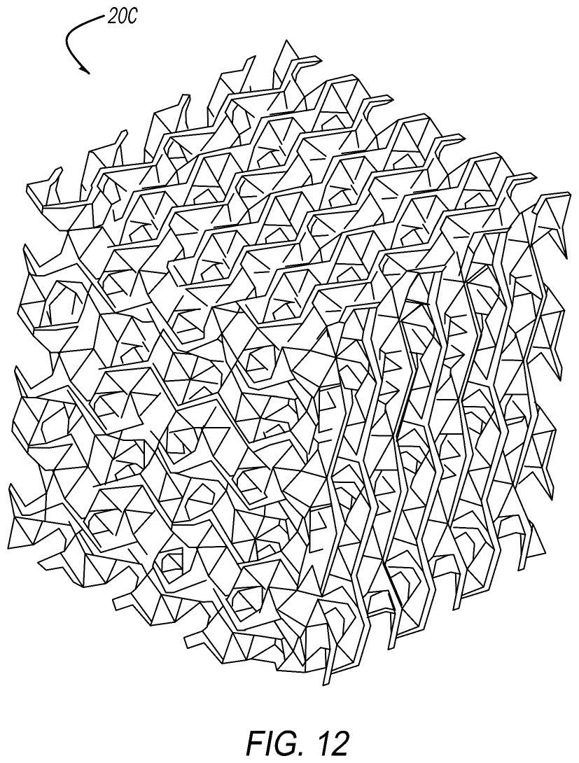

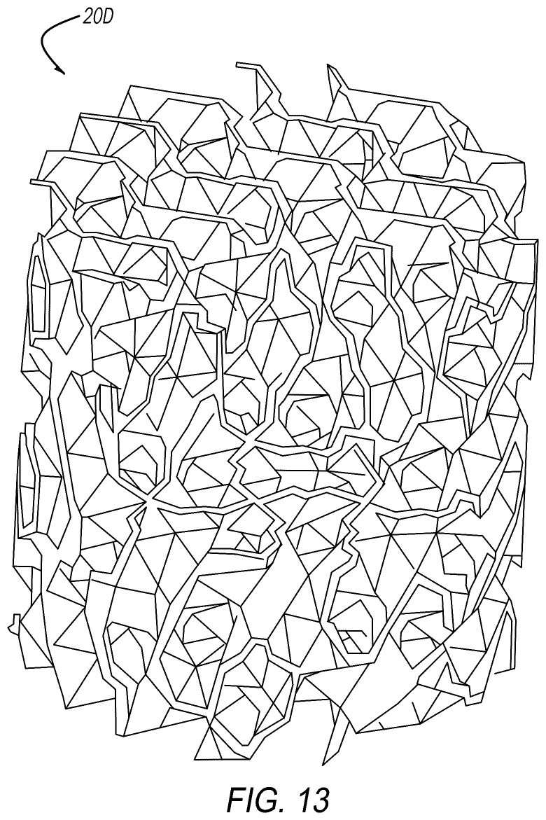

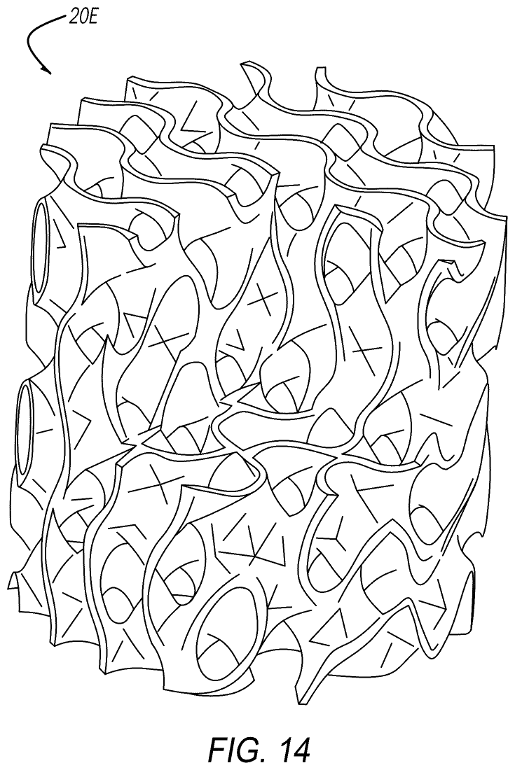

FIG. 11 illustrates an exemplary planar facet pointed structure in accordance with the present disclosure. An angle α9 is defined between the longitudinal axis Y and the wall surface 80, which is less than 90°. FIG. 12 illustrates an exemplary planar facet gyroid lattice of a body 20C, which may be included with the heat exchanger 10 or any other suitable heat exchanger. The body 20D of FIG. 13 is the body 20C trimmed to size by Boolean intersection. FIG. 14 illustrates an additional body 20E, which is a curved facet pointed gyroid body in accordance with the present disclosure.

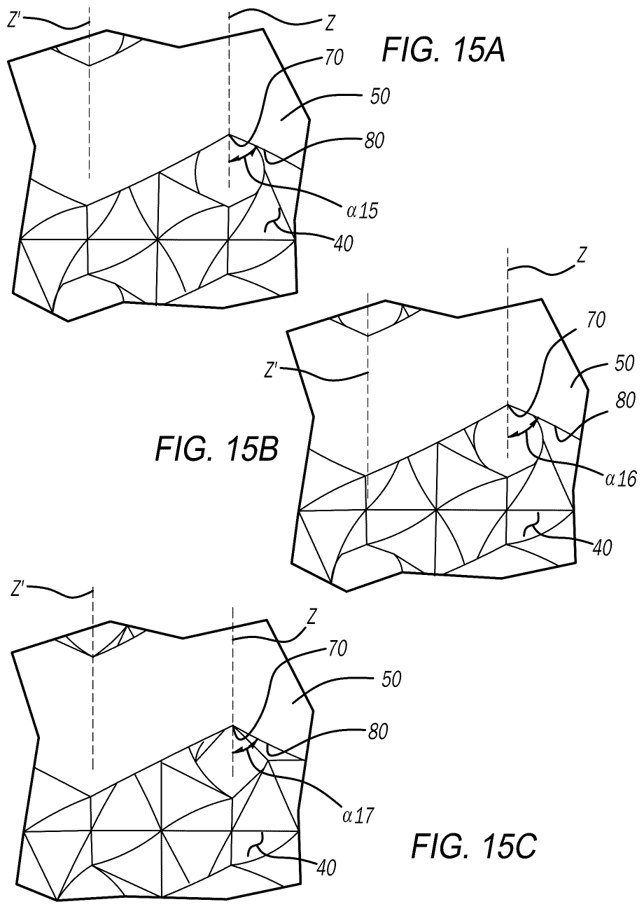

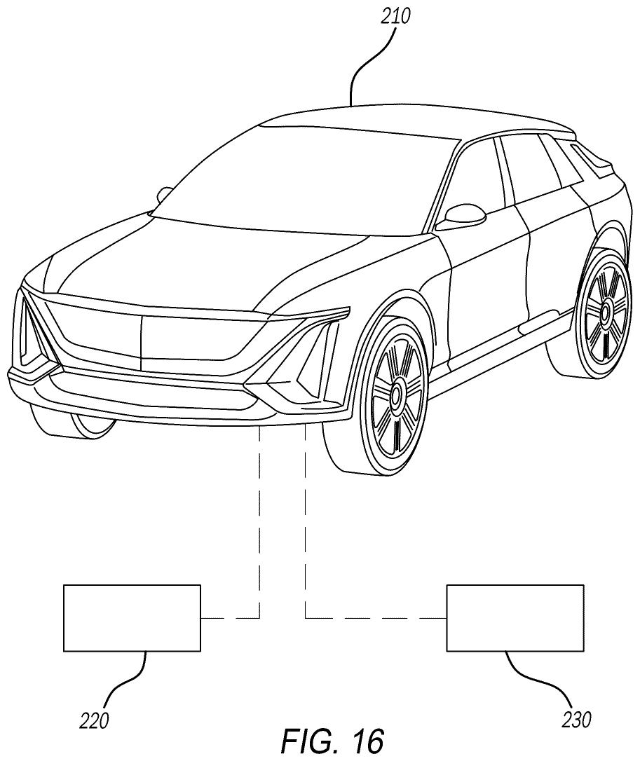

With reference to FIGS. 15A-15C, exemplary generation of the first fluid channels 40 and the second fluid channels 42 (and any suitable number of additional fluid channels) by blending equation derived gyroid structures with planar facet gyroid structures (or any other suitable non-gyroid TPMS structures) using implicit modeling. Curved facet structures will now be described. Using any suitable design software, the user blends the equation derived and the planar facet structures using any suitable implicit modeling mix tool. Both equation derived structures and planar facet structures are generated as perquisites for generating curved facet pointed TPMS (such as gyroid) heat exchangers.

Curved facet structures are formed by blending the equation derived gyroid structures described above with the planar facet gyroid structures described above using implicit modeling functions of any suitable design software. The blended equation derived structures and the planar facet structures may be gyroid shaped or have any other suitable TPMS shape. Any suitable modeling mix tool of any suitable design software may be used.

Depending on the particular design software used, the user will input into the design software a mix factor between 0 and 1 into any suitable mix/blending tool of the design software. In this example, 0 represents 100% of an equation driven structure (such as the structure of FIG. 4, for example) and 1 represents 100% of the planar facet structure (such as the structure of FIG. 11, for example). Any fraction between 0 and 1 favors either the equation driven structure or the planar facet structure in a linear manner. The mix ratio can be adjusted to favor the equation derived structure or the faceted structure, or can be set to 0.5 to create an equal balance of each.

FIG. 15A illustrates an example of a curved facet structure with a mix factor of 0.25 and an angle α15. FIG. 15B illustrates an example of a curved facet structure with a mix factor of 0.50 and an angle of α16. FIG. 15C illustrates an example of a curved facet structure with a mix factor of 0.75 and an angle of α17. The blended structures may be mixed with other blended or non-blended structures. A ramp tool of the design software may be used in conjunction with the mix tool to achieve a ramped blending between other blended or non-blended structures. Each one of the angles α15, α16, and α17 is less than 90°. Thus, the sidewall 50 comes to a point at peak point 70 and is not rounded.

The present disclosure also provides for methods for reducing file size of TPMS based heat exchanger models. In some applications, relatively large file sizes may slow or prevent additive manufacturing of TPMS based heat exchangers, such as gyroid based heat exchangers. Due to the simplified geometry described above, planar facet type pointed TPMS heat exchangers produce additive manufacturing build files having relatively reduced file size as compared to build files produced from standard TPMS heat exchangers with rounded sidewalls.

The pointed TPMS heat exchanger structures described above may be included with any suitable heat exchangers. For example, the pointed TPMS structures may be included in applications where the first fluid channels 40 and the second fluid channels 42 extend continuously and uninterrupted between their respective fluid inlets (such as the first inlet 30 and the second inlet 34) and fluid outlets (such as the first outlet 32 and the second outlet 36) without dead ends. The pointed TPMS structures of the present disclosure may also be included in applications where the first fluid channels 40 and the second fluid channels 42 at an outer periphery of the body 20A (or any of the other bodies disclosed) are generally identical in size to the first fluid channels 40 and the second fluid channels 42 at an interior of the body 20A (or any of the other bodies disclosed).

The present disclosure thus provides for adjustment of the maximum overhang angle of pointed TPMS channels (such as gyroid shaped channels or any other suitable TPMS shape) by asymmetric scaling. For example, the angles α1-α9 and α15-α17 may be set to any suitable angle less than 90°. Such asymmetric scaling results in, for example, (1) improved surface finishes of the channels; and (2) support free manufacturing of TPMS channels of larger channel size. Unlike standard TPMS heat exchangers that are not pointed at the peak point 70 (or the trough point 72) the pointed TPMS heat exchangers of the present disclosure can be tailored to meet the maximum self-supporting overhang angle for given additive manufacturing process parameters (such as additive manufacturing technology, machinery, material, layer height, etc.).

The downskin surfaces of standard TPMS structures may exhibit undesirable surface finishes due to their inherently round downskin surfaces with overhang angles approaching parallel to the build plate. The present disclosure eliminates steep overhang angles on ceiling surfaces at the peaks 60 and the troughs 62, which allows the sidewall 50 to be manufactured at a reduced thickness. With the pointed TPMS heat exchangers of the present disclosure, steep overhang angles are prevented, thereby improving quality, enabling the sidewalls 50 of the channels to be made thinner, a reduction in cell size, greater surface area, and improved heat transfer.

FIG. 16 illustrates a vehicle 210 including wheels and a body supported by the wheels. The heat exchanger 10 and any other heat exchanger in accordance with the present disclosure may be configured for installation in the vehicle 210 or any other suitable vehicle. For example, the heat exchangers of the present disclosure may be configured for installation in a heating, ventilation, and air conditioning (HVAC) system 220 of the vehicle 210. The heat exchangers of the present disclosure may also be configured for installation as part of a battery temperature regulation system 230, for example.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A heat exchanger comprising:
a body including a three-dimensional repeating lattice structure;
first fluid channels defined by the body;
second fluid channels defined by the body; and
sidewalls separating the first fluid channels from the second fluid channels, the sidewalls including pointed tips spaced apart along the sidewalls and separated by curved surfaces of the sidewalls,
wherein the heat exchanger is formed by additive manufacturing.

2. The heat exchanger of claim 1, wherein the body is configured as a modified complex, triply periodic minimal surface (TPMS) structure modified to include the pointed tips.

3. The heat exchanger of claim 1, wherein the heat exchanger is configured for installation in a battery temperature regulation system of a vehicle.

4. The heat exchanger of claim 1, wherein the heat exchanger is configured for installation in a heating, ventilation, and air conditioning (HVAC) system of a vehicle.

5. The heat exchanger of claim 1, wherein the sidewalls are shaped corresponding to a non-sinusoidal wave function.

6. The heat exchanger of claim 1, wherein the sidewalls are shaped corresponding to end points of triangular facets that are coincident to a continuously curved TPMS structure.

7. The heat exchanger of claim 1, wherein the sidewalls are shaped corresponding to a blend of a non-sinusoidal wave function and end points of triangular facets that are coincident to a continuously curved TPMS structure.

8. The heat exchanger of claim 1, wherein the pointed tips include peak points of the sidewalls.

9. The heat exchanger of claim 1, wherein the pointed tips are apex points of the sidewalls.

10. A heat exchanger comprising:
a body including a three-dimensional repeating lattice structure configured as a modified complex, triply periodic minimal surface (TPMS) structure;
first fluid channels defined by the body;
second fluid channels defined by the body; and
sidewalls separating the first fluid channels from the second fluid channels, the sidewalls including pointed peaks spaced apart along the sidewalls and separated by curved surfaces of the sidewalls,
wherein the heat exchanger is formed by additive manufacturing.

11. The heat exchanger of claim 10, wherein the pointed peaks include pointed tips of the sidewalls.

12. The heat exchanger of claim 10, wherein the pointed peaks are apex points of the sidewalls.

13. The heat exchanger of claim 10, wherein the body is configured as the modified complex, triply periodic minimal surface (TPMS) structure modified to include the pointed peaks.

14. The heat exchanger of claim 10, wherein the heat exchanger is configured for installation in a battery temperature regulation system of a vehicle.

15. The heat exchanger of claim 10, wherein the heat exchanger is configured for installation in a heating, ventilation, and air conditioning (HVAC) system of a vehicle.

16. The heat exchanger of claim 10, wherein the sidewalls are shaped corresponding to a non-sinusoidal wave function.

17. The heat exchanger of claim 10, wherein the sidewalls are shaped corresponding to end points of triangular facets that are coincident to a continuously curved TPMS structure.

18. The heat exchanger of claim 10, wherein the sidewalls are shaped corresponding to a blend of a non-sinusoidal wave function and end points of triangular facets that are coincident to a continuously curved TPMS structure.

19. A vehicle comprising:
wheels;
a body supported by the wheels; and
a heat exchanger including:
a body including a three-dimensional repeating lattice structure;
first fluid channels defined by the body;
second fluid channels defined by the body; and
sidewalls separating the first fluid channels from the second fluid channels, the sidewalls including pointed tips spaced apart along the sidewalls and separated by curved surfaces of the sidewalls,
wherein the heat exchanger is formed by additive manufacturing.

20. The vehicle of claim 19, wherein the body is configured as a modified complex, triply periodic minimal surface (TPMS) structure modified to include the pointed tips.
